(19) United States
(12) Patent Application Publication
(10) Pub. No.: US 2007/0130505 A1
(43) Pub. Date: Jun. 7, 2007

(54) TEMPLATE FILLER, METHOD, AND COMPUTER PROGRAM PRODUCT

(76) Inventor: Michael E. Woods, Tiburon, CA (US)

Correspondence Address: PATENT LAW OFFICES OF MICHAEL E. WOODS, 3433 WHEELING DRIVE, SANTA CLARA, CA, 95051, US

(21) Appl. No.: 11/309,551

(22) Filed: Aug. 21, 2006

Related U.S. Application Data
(60) Provisional application No. 60/595,968, filed on Aug. 21, 2005.

(51) Int. Cl. G06F 17/00; G06F 17/30

(52) U.S. Cl. 715/505; 715/507; 707/1

(57) ABSTRACT

A system, method, computer program product and propagated signal for generating one or more forms in one operation using data identified in a dynamically generated user editable form that includes a list limited to the fillable fields of the form templates and prospective data to be substituted into those fields when the forms are generated from the selected form templates, particularly using forms in PDF that may be accessed using an API.

### BACKGROUND OF THE INVENTION

The present invention relates generally to form generation from form templates and more specifically to generation of one or more forms in one operation using data identified in a dynamically generated user editable form that includes a list limited to the fillable fields of the form templates and prospective data to be substituted into those fields when the forms are generated from the selected form templates.

Forms are well-known—in fact forms are ubiquitous in both the hard copy physical world and in the virtual intangible online world of the Internet and the World Wide Web (WWW). There are many products and systems for helping a user generate a filled-in copy of a form from a form template; and many of the products and systems assist in filling in the form with user data.

Typical products include proprietary forms using proprietary front-ends. Many of these products include a database of some type permitting a user to enter data to be used in the form-filling process. Typically a user selects a record from the database and then identifies a form and the product generates a copy of the form using appropriate data from the database.

When the user desires to complete three forms, it is not uncommon for the user to perform the form generation three times in succession, once for each form. When a user desires to generate a set of forms based upon data not in the database, they setup the database record first then enter a form selection mode from the database record. This is necessary even when a desired set of forms include only a few fields from the database record. Typically the user does not know what all the fields are that are going to be filled in from the database record, making pre-review of the form data more difficult. There is no way for a user to temporarily substitute desired data for to be used for the form generation only—they must change the data record to use the temporary data, generate the form, and then change the database record back. Finally with many of the proprietary formats, modifying the generated forms is often difficult when possible at all.

For example, the United States Patent and Trademark Office (USPTO) makes available for download from its website (www.uspto.gov) a set of approved forms for patent and trademark purposes. These forms are in Adobe Acrobat portable document format (PDF)—and they are of two types: standard and fillable. The standard type requires that a user print out the form, then use a typewriter to enter data into the form. This is very undesirable for many reasons including it is time inefficient to print each form then manually enter data into appropriate locations on the form and it increases the possibility of introducing errors as it is common that the same data is repeated on multiple forms.

The fillable type is an improvement in that the form has been defined using user-editable fields that receive typed input from the user. The user is able to use an Adobe Acrobat product to move to the predefined fields and enter the data prior to printing the completed forms. This is much more efficient than using the typewriter because it is simple to move to the proper location where data may be recorded and it is simple to edit data that has been entered into the field. However, it is still time inefficient in that it is common when using these forms that multiple ones of the forms are completed with the same information. The user must still manually enter all the data in all the forms, which can increase errors and is still inefficient in terms of time as duplicate information is entered multiple times. An additional difficulty is one of organization: the forms are identified by computer-compatible names and may not be helpful to a user trying to find the correct form to begin to fill out, particularly when time deadlines approach.

Thus users of forms such as the USPTO forms are currently required to choose between two unpleasant alternatives: use proprietary solutions that replicate the forms or use the USPTO forms or use the USPTO forms that are time inefficient and have increased opportunity for error. The proprietary solutions are typically inflexible and can be expensive and slow to respond to form changes periodically made by the USPTO.

It is certainly preferable to find a solution that permits use of the USPTO-provided PDF-fillable forms as the forms are easily obtained, it is easy to replace outdated forms with new forms, and there is no possibility of inconsistencies between the language or other content of the USPTO form and the form used. This is another disadvantage of proprietary forms—it is possible that inconsistent or errant language may be introduced between the proprietary form and the statutory requirements represented by the USPTO-provided forms.

What is needed is a system, method, computer program product and propagated signal for generating one or more forms in one operation using data identified in a dynamically generated user editable form that includes a list limited to the fillable fields of the form templates and prospective data to be substituted into those fields when the forms are generated from the selected form templates, particularly using forms in PDF that may be accessed using an API.

### BRIEF SUMMARY OF THE INVENTION

A system, method, computer program product and propagated signal for generating one or more forms in one operation using data identified in a dynamically generated user editable form that includes a list limited to the fillable fields of the form templates and prospective data to be substituted into those fields when the forms are generated from the selected form templates, particularly using forms in PDF that may be accessed using an API.

One aspect of the preferred embodiment includes a method, the method including: a) identifying dynamically one or more form fields in one or more selected form templates to produce a composite form field list; b) generating a user-editable pre-fill dynamic form of the composite form field list, the user-editable pre-fill dynamic form including a plurality of field substitution data; and c) generating a set of filled-in user forms wherein the field substitution data of the user-editable pre-fill dynamic form is substituted into the one or more form fields of the one or more selected form templates. This method may in some cases be implemented by program instructions of a computer program product and/or of a propagated signal.

Another aspect of the preferred embodiment is a system, the system including a set of form templates, each template defined using a page description language (PDL) and including one or more form fields accessible using an application programming interface (API); and a specially-programmed computing system including resources for controlling a processor, the processor for: receiving a user input to identify a collection of form templates, the collection selected from the set of form templates; generating a composite field list of the form fields of the form templates of the collection using the API; mapping the composite field list into a pre-fill field list responsive to a field map; accessing a data repository to retrieve a plurality of substitution data for the pre-fill field list; producing dynamically a user-editable pre-fill form having the pre-fill field list and corresponding data from the plurality of substitution data; responding to an editing input to modify the corresponding data and produce a modified plurality of substitution data; and generating forms from the collection of form templates using the modified plurality of substitution data and the API.

The preferred embodiments of the present invention offer the advantages of using non-proprietary form templates, such as those provided by a third-party, with the improved time efficiencies, reduced error possibilities, and organizational advantages of proprietary systems.

### BRIEF DESCRIPTION OF THE DRAWINGS

FIG. 1 is a computer system that may function as a basic computer in implementing a preferred embodiment of the present invention for an efficient template filler solution that provides a user with a simple and quick mechanism for identifying form templates, reviewing/editing data for the selected forms and generating the forms with the appropriate data;

FIG. 2 is an illustration of a preferred embodiment for a networked templating system;

FIG. 3 is a generic computer of the system shown in FIG. 2;

FIG. 4 is an overview illustration of a preferred embodiment for process flow of the present invention;

FIG. 5 is a specific illustration of a representative implementation of the process flow shown in FIG. 4;

FIG. 6 is an example of a form selection interface of a preferred embodiment;

FIG. 7 is an example of a record selection interface of a preferred embodiment;

FIG. 8 is an example of a generalized mapping interface of a preferred embodiment;

FIG. 9 is an example of a preferred embodiment for a field alias assignment interface;

FIG. 10 is an example of an alias assignment interface of the interface shown in FIG. 9;

FIG. 11 is a specific example of a mapper interface of a preferred embodiment; and

FIG. 12 is a process flow for a preferred embodiment of a template filler user process.

### DETAILED DESCRIPTION OF THE INVENTION

The preferred embodiments of the present invention relate to generating one or more forms in one operation using data identified in a dynamically generated user editable form that includes a list limited to the fillable fields of the form templates and prospective data to be substituted into those fields when the forms are generated from the selected form templates, particularly using forms in PDF that may be accessed using an API. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

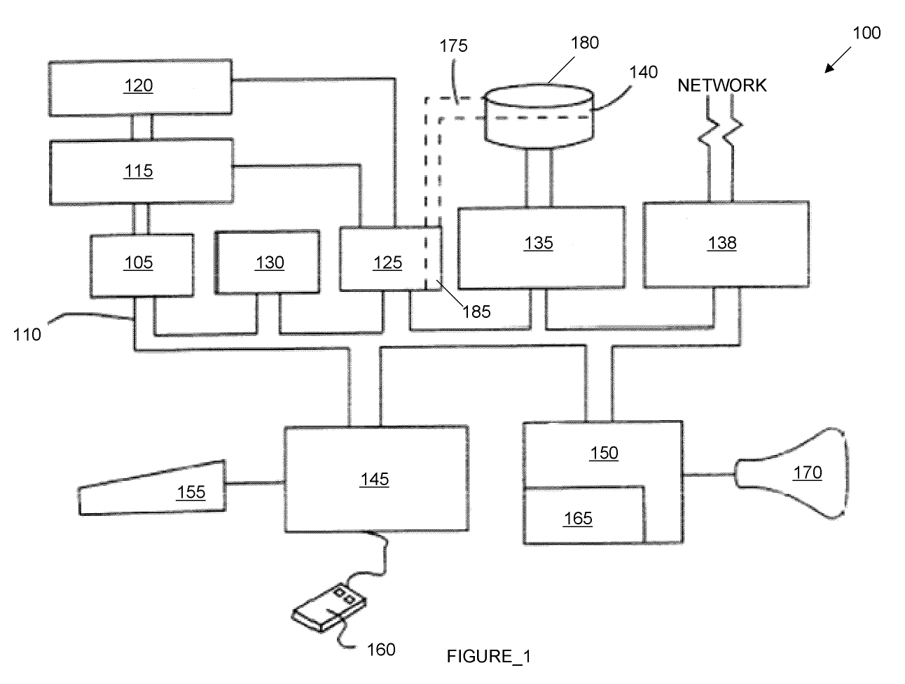

FIG. 1 is a computer system 100 that may function as a basic computer in implementing preferred embodiments of the present invention for an efficient form template filler solution that provides a user with simple and quick and accurate data substitutions into selected form templates. Computer system 100 includes a central processing unit (CPU) 105, such as one of the PC microprocessors or workstations, e.g. RISC System/6000 (RS/6000) (RISC System/6000 is a trademark of International Business Machines Corporation) series available from International Business Machines Corporation (IBM) or other processors from Advanced Micro Devices, Intel, Motorola, MIPS Technologies, Inc., and the like, is provided and interconnected to various other components by a system bus 110. An operating system 115 runs on CPU 105, provides control and is used to coordinate the function of the various components of FIG. 1. Operating system 115 may be one of the commercially available operating systems such as the AIX 6000 operating system or OS/2 operating system available from IBM (AIX 6000 and OS/2 are trademarks of IBM); Microsoft's Windows (95, 98, ME, NT, 2000, and XP), as well as UNIX and AIX or Apple Computer operating systems. One or more application programs 120, controlled by the system, are moved into and out of a main memory RAM 125. These programs include the program of the present invention to be subsequently described in combination with local or wide-area network systems, such as for example, the Internet. A read only memory (ROM) 130 is connected to CPU 105 via bus 110 and includes the Basic Input/Output System (BIOS) that controls the basic computer functions. RAM 125, an I/O adapter 135 and a communications adapter 138 are also interconnected to system bus 110. I/O adapter 135 may be a Small Computer System Interface (SCSI) adapter that communicates with a disk storage device 140, though other well-known interfaces may be used. Communications adapter 135 interconnects bus 110 with an outside network enabling the data processing system to communicate with other such systems over a Local Area Network (LAN) or Wide Area Network (WAN), which includes, of course, the Internet, the WEB, intranets, extranets, and other public and private networks. The terms associated with the network are meant to be generally interchangeable and are so used in the present description of the distribution network. I/O devices are also connected to system bus 110 via a user interface adapter 145 and a display adapter 150. A keyboard 155 and a pointing device (e.g., mouse 160) are all interconnected to bus 110 through user interface adapter 145. It is through such input devices that the user may interactively relate to the programs for an efficient interface solution that provides a user with simple and quick searches\retrievals\accesses across a plurality of locations, and one that may be expanded without complicated or time-consuming configuration options according to the preferred embodiments. Display adapter 150 includes a frame buffer 165, which is a storage device that holds a representation of each pixel on a monitor or display screen 170. Images may be stored in frame buffer 165 for display on monitor 170 through various components, such as a digital to analog converter (not shown) and the like. By using the aforementioned I/O devices, a user is capable of inputting information to the system through the keyboard 155 or mouse 160 and receiving output information from the system via display 170. The system also contains a memory cache 175 which is illustrated as a dashed line outline and includes a portion 180 of a disk storage drive 140 and a portion 185 of RAM 125.

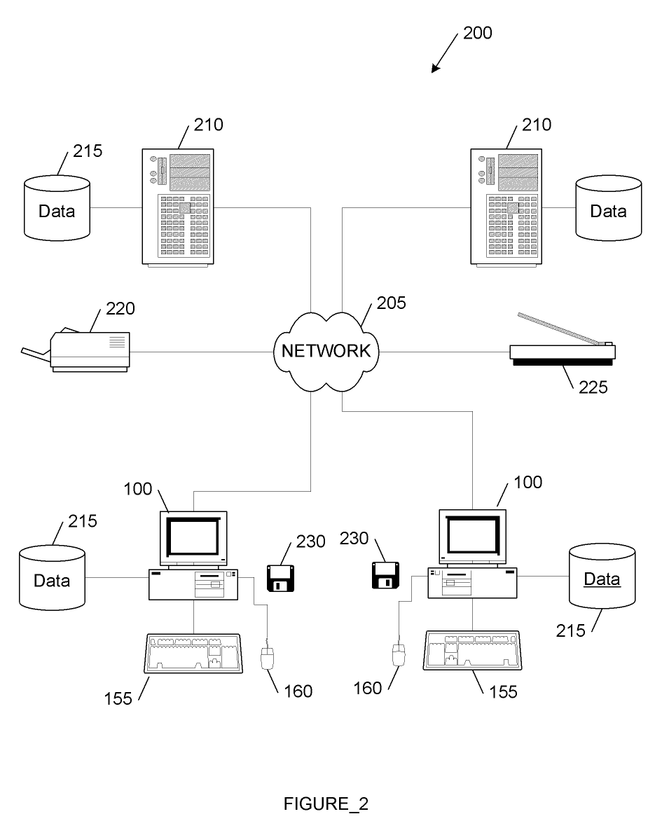

FIG. 2 is an illustration of a preferred embodiment for a networked templating system 200 including a plurality of computing systems 100 shown in FIG. 1 connected to a network 205 (e.g., the Internet or local/wide area networks (LANs/WANs) and the like) to other computing systems 210 (e.g., world wide web (www) servers, data servers, application servers and other computing systems of the type shown as computing system 100 shown in FIG. 1). Computing systems 100 and 210 include connection to data repositories 215 that may be of any of the well-known data management and organizational systems, including databases and data structures of a wide variety of types including relational databases (MS SQL, MySQL, DB2, and the like) of flatfile databases including XML, comma-delimited, and the like, among other data repositories. Typically the actual data contained in the various data repositories 215 varies from computing system to computing system though there are methods and systems for synchronizing and backing up data repository contents among the various data repositories. System 200 of the preferred embodiment also includes a printer 220 and an optional scanner 225. System 200 includes a computer-system-readable medium 230 (e.g., floppy disk, magneto-optic disk, or other portable storage mechanism for persistent storage of data and/or computer program instructions).

System 200 of the preferred embodiment provides a mechanism for accessing, retrieving, identifying, configuring, filling, saving, generating, and otherwise processing form templates, form template data, and filled-in forms, particularly in response to user input into a computing system 100.

As a broad overview, there are two major functions implemented by the preferred embodiment of system 200. There is an administrator function and a user function; however in some embodiments and implementations these functions may be integrated. The administrator function is for locating, retrieving, configuring, and processing form templates. Form templates may be retrieved from local and remote (via network 205) data repositories 215, such as a compressed file of a set of form templates available from the USPTO www site: (http://www.uspto.gov/web/forms/index.html), the Adobe Acrobat fillable forms thereon are hereby expressly incorporated by reference for all purposes.

The USPTO fillable forms are used herein to simplify the discussion of the present invention, however it is the case that other forms, in other formats, from other sources may also be implemented including administrator originated custom forms, either singly or in a group or collection. The preferred embodiments address use of third-party fillable Adobe Acrobat form templates when a group of the templates are to be filled in at one time using data common to the form templates.

It is a characteristic of form templates that each contains a plurality of fields, with each field having a name. No single universal convention exists for naming these fields so field names in the templates varies from template to template, and even between versions of the same form template in some cases. For example, in the USPTO forms, a field appearing on multiple ones of the forms is provided for receiving an application number. In some cases, the field name on one template may provide a user with an idea of the intended content, such as by being named “Application_Number” however another form template in the same set may name a field intended for the same content as “App_No” or “AppNo” or similar variation. There is no requirement that the field name even has any obvious meaning, thus a field for application number content may be named “Field 107” or “ddfgoowk” or other similar apparently meaningless name. Thus a collection of form templates may include a wide variety of field names, sometimes for the same intended content. Thus one feature of the administrator function is to provide administrator-desired alias names for fields on the form templates of the set, when necessary or desirable. This is provided as an aid to the administrator function and may not in all cases be implemented. When this alias assignment feature is implemented, field names of the form templates are aliased, preferably using a consistent naming convention understood by the administrator. For example, an alias of ApplicationNo may be adopted for a field for handling the application number content, with ApplicationNo aliased to all the fields of the set of form templates. Thus Application_Number, App_No, AppNo, Field 107, and ddfgoowk are all aliased to ApplicationNo. Similarly, Registration Number (and variants) are aliased to RegNo.

Another administrator feature defines one or more templates for data repositories 215 to be used in system 200. In the preferred embodiment adapted for the USPTO form templates, the data repository templates are divided into a common template and a record template. The following discussion describes this preferred embodiment; however it is understood that other form collections, implementation requirements, or other embodiments, the details will vary from that described below.

The common template for a data repository includes those fields which, for the particular application, are anticipated to be common to the form template collection. As an example, when the USPTO forms are implemented by a solo Patent Attorney, Patent Agent or inventor, the common data template fields may include the practitioner name, correspondence details, registration number (e.g., RegNo), customer number, deposit account, and the like as appropriate. The record template for the data repository includes those fields which, for the particular application, are anticipated to be variable for different uses of system 200. In the present example, the record template includes fields for the application number (e.g., AppNo), the application title, the Examiner Name, inventor and assignee name and related information, and the like.

Another feature of the administrator function is to define a map for the form templates of the collection. This map creates a correspondence between the fields of the form templates and the fields of the common/record templates. For example, the alias ApplicationNo is mapped to AppNo in the record template and the alias RegNo is mapped to RegNo in the common template.

In the preferred embodiment for this implementation, the mapper feature maps only those fields from the form templates of the form collection that have been aliased. In other words, a particular form template (e.g., Form_1) may have ten fillable fields defined, but aliases may have been made for only two (e.g., ApplicationNo and RegNo). In the mapper feature, Form_1 will have the two aliased fields available for mapping, one to AppNo and the other to RegNo as described above. This mapping feature may be performed manually or it may be performed programmatically. It is possible to programmatically create common data/record data (CD/RD) templates and to map form templates fields to the CD/RD templates, particularly when a uniform naming convention is used. For example when the field names in the CD/RD templates match those of form templates a simple straightforward mapping may be used.

The mapping feature also provides an ability to provide user-friendly form and field names and may be included in the map or in an additional description data structure of data repository 215. Further, the described features of the administrator function may be implemented separately, such as by providing an Adobe Acrobat compatible plug-in for performing alias assignment directly when a form template is opened. A CD/RD template creator process is implemented to define field names in the CD template and in the RD template. A mapper process analyzes an identified group of form templates having aliases, and creates the map between the aliased fields of the group of form templates and the CD/RD templates, and provides the user-friendly description of the form templates. In other implementations, these features are implemented differently or grouped differently in a plug-in or standalone process or combination thereof.

As a result of the administrator function, the form templates of the collection have been mapped, described and the CD/RD templates have been defined.

The user function uses the map and CD/RD templates to fill the aliased fields of set of the form templates with data from data repository 215. One feature of the user function is for the user to identify the collection of form templates for any particular use. After selecting the form templates, the user may select an existing record or decide to create a new record. An interface element is generated dynamically based upon the choices made by the user: the aliased fields from the selected form templates are determined to create a composite field list of the aliased field in the selection. Mapped common data is included in the interface corresponding to the aliased fields in the composite list as identified in the map. Additionally, record data from the identified record (if any) is also included in the interface, again corresponding to the aliased fields in the composite list as identified in the map. The CD/RD data is editable and once the user is satisfied that the common and record data in the interface is the intended data, the user initiates the form completion process to fill the selected form templates with the data form the interface. The user has the option to save the data in the interface window-fields are saved into the common data structure or into the opened or new record data structure. The preferred embodiment actually creates a copy of each of the form templates of the selection and substitutes the data of the dynamic interface into the copies as appropriate. These copies are saved and opened in the default application associated with the form type (e.g., in an Adobe Acrobat product like Reader). After opening, each form may be further edited using the opening application features.

Note that the dynamically generated interface includes only those fields from the CD/RD templates that are actually used in the selected form templates. This reduces the effort required to review/check the data used in form generation. It is also a consequence of this implementation of the preferred embodiment that not all data fields of the CD/RD templates are necessary to be filled in, or in some cases, will ever be filled in depending upon the particular collection of form templates used. In some cases, when an existing form template set is opened with an existing record, all the fields may be prefilled, none of the fields, or some of them. Whenever the data in the interface is completed or edited, the updated information may be substituted for the current data, increasing the value of the data in the data repository by making it more extensive or more current.

Filled-in forms may be generated from system 200 using printer 220 when the forms are completed satisfactorily. Scanner 225 enables one avenue for generation of new forms. A paper form may be scanned into a page description program (like Adobe® Acrobat®) that permits fields to be created in the PDF document. Other electronic forms (such as from word processing programs and spreadsheets) may be converted into PDF and then processed similarly to create fillable-form templates.

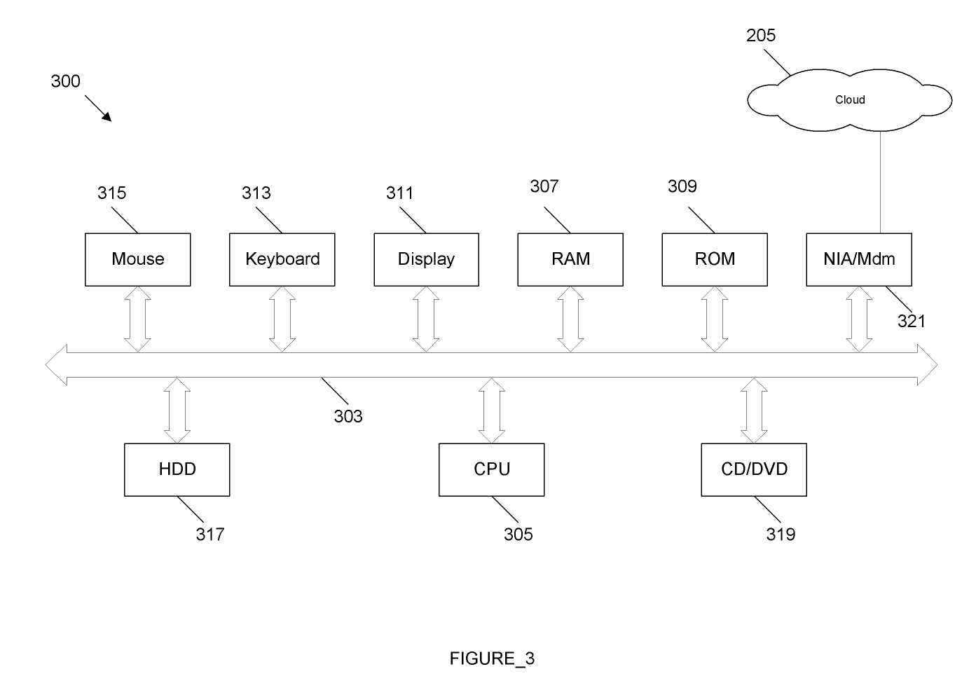

As schematically shown in FIG. 3, a generic computer 300 of system 200, e.g. the computing system 100 or server 210, includes several functional units connected in parallel to a data communication bus 303, for example of the PCI type. In particular, a Central Processing Unit (CPU) 305, typically comprising a microprocessor, controls the operation of computer 300, a working memory 307, typically a RAM (Random Access Memory) is directly exploited by the CPU 305 for the execution of programs and for temporary storage of data, and a Read Only Memory (ROM) 309 stores a basic program for the bootstrap of computer 300. Computer 300 comprises several peripheral units, connected to the bus 303 by means of respective interfaces. Particularly, the peripheral units that allow the interaction with a human user are provided, such as a display device 311 (for example a CRT, an LCD or a plasma monitor), a keyboard 313 and a pointing device 315 (for example a mouse or a trackpoint). Computer 300 also includes peripheral units for local mass-storage of programs (operating system, application programs) and data, such as one or more magnetic Hard-Disk Drivers (HDD), globally indicated as 317, driving magnetic hard disks, and a CD-ROM/DVD driver 319, or a CD-ROM/DVD juke-box, for reading/writing CD-ROMs/DVDs Other peripheral units may be present, such as a floppy-disk driver for reading/writing floppy disks, a memory card reader for reading/writing memory cards and the like. Computer 300 is further equipped with a Network Interface Adapter (NIA) card 321 for the connection to the data communication network 205; alternatively, computer 300 may be connected to the data communication network 205 by means of a MODEM. Of course, computer 300 could also be configured according to FIG. 2 as well-known, with FIG. 1 and FIG. 2 describing alternative systems.

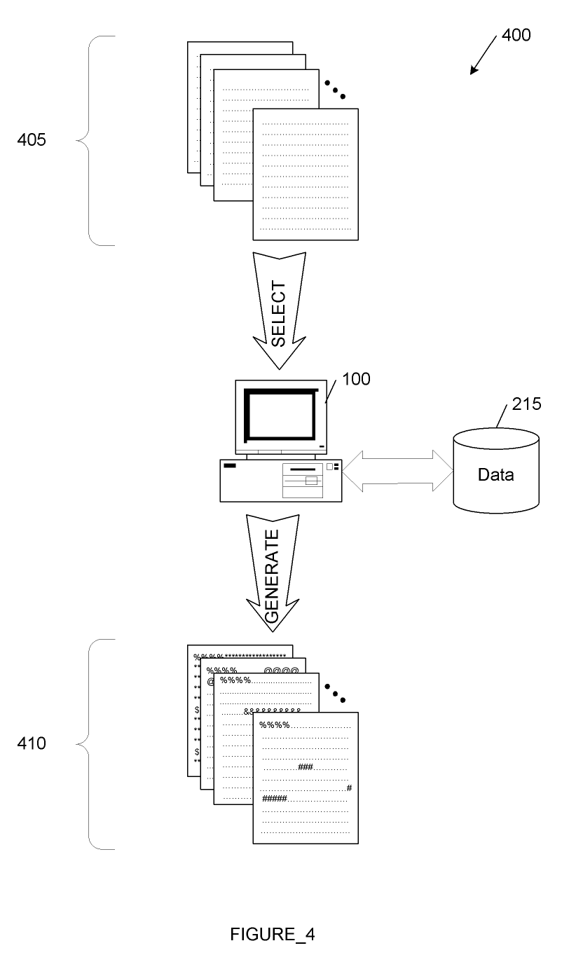

FIG. 4 is an overview illustration of a preferred embodiment for a process flow 400 of the present invention. Process flow 400 receives a set of form templates 405, preferably in fillable Adobe Acrobat-compliant format, processes successively one or more groups of them as described herein using computing system 100 and data repository 215, to produce a set of filled in forms 410. The preferred embodiment uses features available from the Adobe Acrobat Software Development Kit (SDK) such as available from Adobe, Inc., at http://partners.adobe.com/public/developer/acrobat/sdk/index.html provided for different versions of Adobe Acrobat. The full Adobe® Acrobat® SDK contains the documentation, headers, sample code, and tools for building plug-ins, integrating Acrobat Standard, Acrobat Professional, and Adobe Reader into another solution, or automating processes. The SDKs are hereby expressly incorporated by reference in their entireties for all purposes.

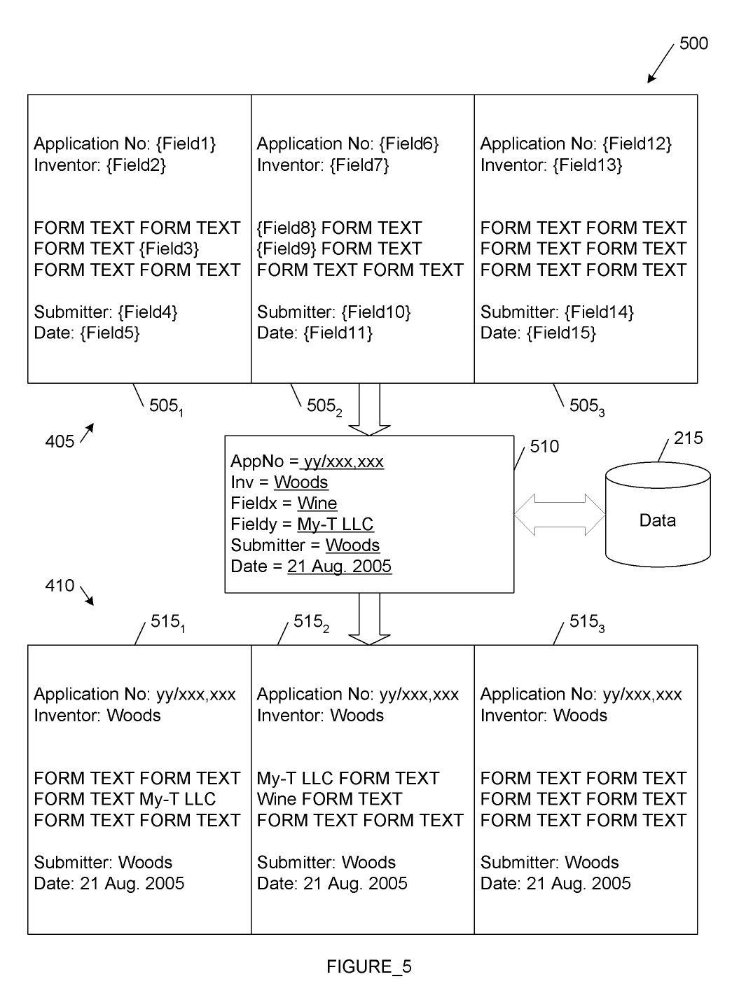

FIG. 5 is a specific illustration of a representative implementation 500 of process flow 400 shown in FIG. 4. Process flow 500 includes three selected form templates 505 (e.g., form_1 505₁, form_2 505₂, and form_3 505₃) of form templates 410. Computing system 100, in cooperation with data repository 215, creates a dynamic pre-fill interface 510 with aliased fields from selected form templates 505, interface 510 includes editable data from the composite list with relevant data from data repository 215. In form templates 505, there are a total of fifteen aliased fields, identified as {FieldN}, N=1to 15. In this example, {Field1 }, {Field6}, and {Field12} are aliased and mapped to AppNo. Similarly {Field2}, {Field7}, and {Field13} are aliased and mapped to Inv. {Field4}, {Field10}, and {Field14} are aliased and mapped to Submitter. {Field5}, {Field11}, and {Field15} are aliased and mapped to Date. {Field3} and {Field8} are aliased and mapped to Fieldy, while {Field9} is aliased and mapped to Fieldx. The fields AppNo, Inv, Fieldx, Fieldy, and Date are all included in the record data template and Submitter is included in the common data template. The corresponding data from the CD/RD templates and data structures in data repository 215 are shown in interface 510 corresponding to the aliased fields from templates 505. A user may update, modify, change, and/or delete substitution data (data to be provided into templates 505) in interface 510 as necessary or desirable and then generate three forms 515 of form set 410 (a form_1 515₁ corresponds to form_1 505₁, a form_2 515₂ corresponds to form_2 505₂, and a form_3 515₃ corresponds to form_3 505₃ having appropriate substituted data entered into the appropriate form fields).

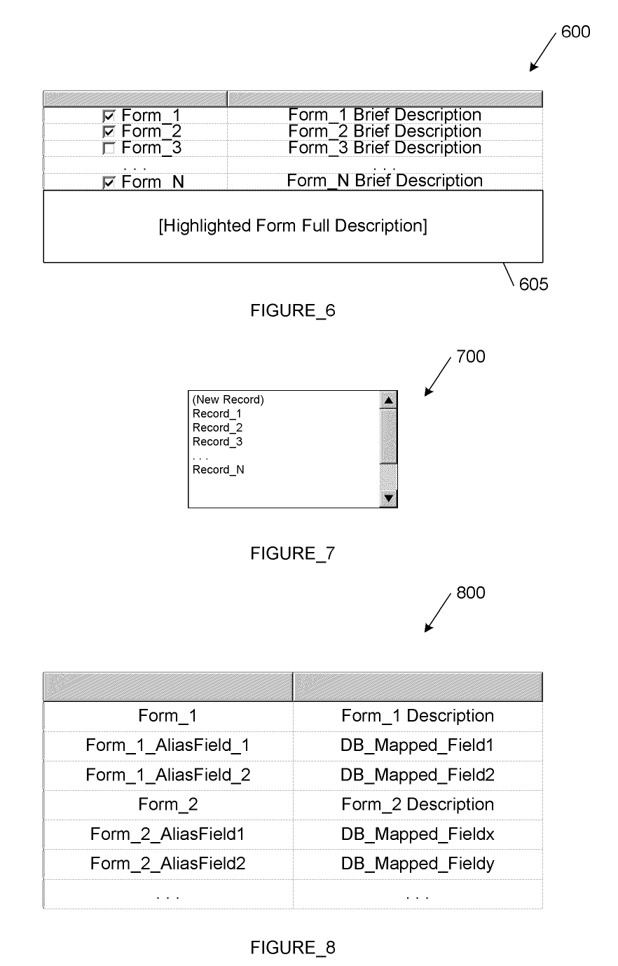

FIG. 6 is an example of a form selection interface 600 of a preferred embodiment. Interface 600 permits a user to choose form templates 505. Interface 600 includes a form name with a corresponding brief form description. When a form is highlighted, such as positioning a cursor over the line containing the form, a full form description appears in a window 605.

FIG. 7 is an example of a record selection interface 700 of a preferred embodiment. Interface 700 permits the user to choose an existing record or new record during use of system 200.

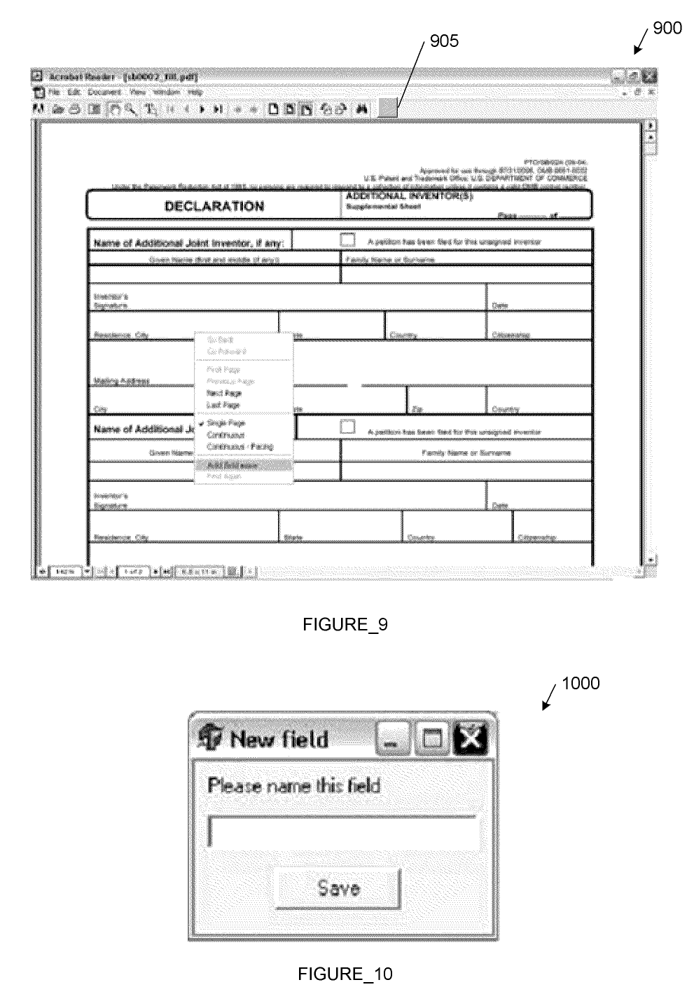

FIG. 8 is an example of a generalized mapping interface 800 of a preferred embodiment. Interface 800 creates a map that identifies, for each form template being mapped, the form and the aliased fields of that form template (left-hand column). In the right hand column is correspondingly a form description and mapped field from the CD/RD templates, respectively. The description provides both the brief and full version in interface 600 (based upon a length of the field in interface 600 versus a length of the field in interface 800. FIG. 9 is an example of a preferred embodiment for a field alias assignment interface 900. Interface 900 is enabled by use of a plug-in for Adobe® Acrobat® Reader when a form template is opened and a control 905 for the plug-in is enabled. Enabling the plug-in provides an option for producing a new interface when processing a field of the opened field template. In this case, the option is “Add New Alias Field Name” to assign an alias name to certain fields of the opened form template.

FIG. 10 is an example of an alias assignment interface 1000 of the interface shown in FIG. 9. Interface 1000 actually creates the alias name for use with the form template.

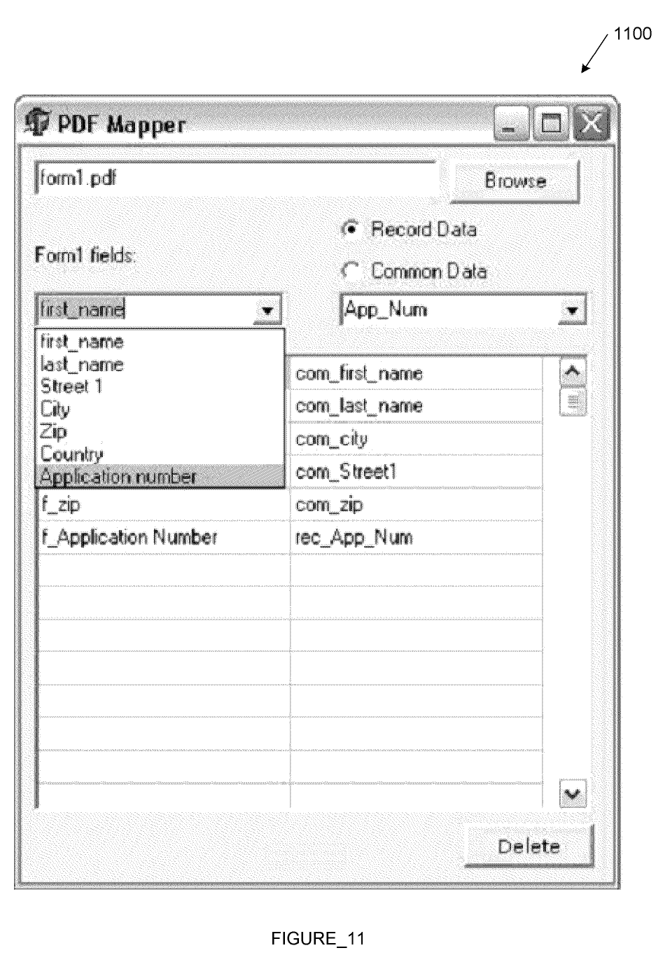

FIG. 11 is a specific example of a mapper interface 1100 of a preferred embodiment. Interface 1100 is responsive to opening a set templates 405—to determine which alias fields in which specific form corresponds to which data field in the CD/RD templates. Some or all of the mappings are done to produce the map file that, in addition to the CD template and the RD template are used with the user function to generate forms from the field templates.

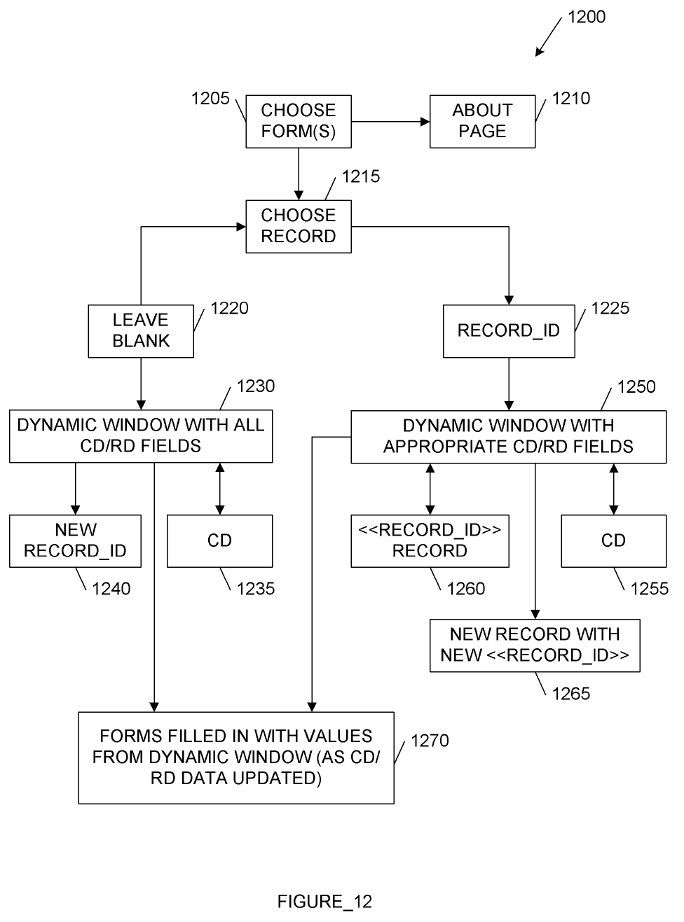

FIG. 12 is a process flow diagram for a preferred embodiment of a template filler user process 1200. Process 1200 starts in the preferred embodiment using a form-centric approach of choosing a set of aliased and mapped form templates (step 1205) for filling. A user may desire to find out more information about the process and choose an About control of the user program interface to produce an About Page (step 1210). Instead of choosing step 1210, a user next (after choosing forms in step 1205) chooses a record at step 1215. The user may either leave the choice blank (step 1220) or select an existing record using a <<record_id>>(step 1225).

Step 1220 starts a branch where a user may create a new record entry using the record data template (or to generate forms using data from only the common data template) by generating a window having all the fields from the CD/RD templates (step 1230). Step 1230 generates dynamically the user pre-fill window that receives common data from a data repository (step 1235) and enters it into the dynamic window and blank spaces corresponding to the record data template fields. The data in the dynamic window may be edited: the common data read from the data repository may be changed/deleted and, optionally, written back into the data repository at the user's election. Similarly, data for the record data templates (some or all fields may have data provided) may be written (optionally) to the data repository to create a new record that may be subsequently opened in step 1215.

When a user has selected an existing record at step 1215, a particular one record is opened from the data repository and step 1250 generates dynamically another interface control. This window is similar to the window generated from step 1230 except in this case, record data may also be available from the data repository. CD and RD are read (step 1255 and step 1260) to pre-fill the corresponding data for aliased and mapped fields of the selected form templates. Just as before, this interface allows the user to review, edit, update, and otherwise process the data from the data repository and optionally save them back into the data repository as updated common data and/or updated record data, and/or create a brand new record with a new record_id (step 1265). The interface window from step 1230 and from step 1250 next permits the user to generate the filled-in forms 515 from the selected form templates 505 (step 1270). Forms 515 may then be modified, printed, saved, and used as desired.

Many of the preferred embodiments of the present invention are described as a local system in which form templates and data is stored and processed locally. As described, some features and data storage may be implemented in a network or group collaboration. It is also a preferred embodiment of the present invention to provide a network version or an online version of some of the preferred embodiments as appropriate. There are features and advantages available in one implementation that may not be available in other implementations. For example, the network version permits multiple users to share record data and the form template collection. In the online version, the data repository for the CD/RD may be local and used by form templates, and maps and other form processing features online. The forms may be generated remotely or locally depending upon features to be implemented. The preferred embodiments may be extended by enabling use of the CD/RD data with other types of form templates. For example, there are other templating programs that define fields, such as available in word processing programs. Word processing templates and other electronic templates that identify fields may be used with the system by enabling such documents to be mapped and selected. Data from CD/RD may be provided to these templates.

As should be clear, the present invention is not limited to any particular operating system, CPU-type, resource access application (e.g., a specific browser-type) or type or types of resources accessed or retrieved. The preferred embodiments of the present invention may be implemented/adapted for many different platforms, operating systems, computing systems, interfaces, resource access applications and the like without departing from the spirit and teachings of the present invention.

In some of these implementations, interface 510 or others of the interfaces or features may be integrated into an application (e.g., Adobe® Acrobat®), process, or operating system process or method. One or more of the interface elements, data repository, or other component may be networked, implemented as a client server application, distributed across a network of interconnected processing units (including Internet and browser-based technologies).

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this may be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system shown in FIG. 1, FIG. 2, and/or FIG. 3, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines may operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A method, the method comprising:
a) identifying dynamically one or more form fields in one or more selected form templates to produce a composite form field list;
b) generating a user-editable pre-fill dynamic form of said composite form field list, said user-editable pre-fill dynamic form including a plurality of field substitution data; and
c) generating a set of filled-in user forms wherein said field substitution data of said user-editable pre-fill dynamic form is substituted into said one or more form fields of said one or more selected form templates.

2. The method of claim 1 wherein said user-editable pre-fill dynamic form generation includes:
b1) accessing a data repository to retrieve an initial set of said field substitution data; and
b2) providing said initial set of said field substitution data for presentation in said generated user-editable pre-fill dynamic form.

3. The method of claim 2 wherein said data repository includes a first subset of field substitution data common to a set of form templates that said one or more selected form templates are selected from and includes a second subset of field substitution data variable to said set of form templates.

4. The method of claim 1 wherein said user-editable pre-fill dynamic form includes a set of pre-fill fields and wherein said composite form field list is produced using a mapping reference that associates one or more form fields of said selected form templates to predetermined fields of said set of pre-fill fields.

5. The method of claim 4 wherein two or more of said form fields of said selected form templates are associated with one pre-fill field.

6. The method of claim 1 wherein said plurality of field substitution data is limited to fillable fields of said selected form templates.

7. A computer program product comprising a computer readable medium carrying program instructions for generating one or more forms when executed using a computing system, the executed program instructions executing a method, the method comprising:
a) identifying dynamically one or more form fields in one or more selected form templates to produce a composite form field list;
b) generating a user-editable pre-fill dynamic form of said composite form field list, said user-editable pre-fill dynamic form including a plurality of field substitution data; and
c) generating a set of filled-in user forms wherein said field substitution data of said user-editable pre-fill dynamic form is substituted into said one or more form fields of said one or more selected form templates.

8. The computer program product of claim 7 wherein said user-editable pre-fill dynamic form generation includes:
b1) accessing a data repository to retrieve an initial set of said field substitution data; and
b2) providing said initial set of said field substitution data for presentation in said generated user-editable pre-fill dynamic form.

9. The computer program product of claim 8 wherein said data repository includes a first subset of field substitution data common to a set of form templates that said one or more selected form templates are selected from and includes a second subset of field substitution data variable to said set of form templates.

10. The computer program product of claim 7 wherein said user-editable pre-fill dynamic form includes a set of pre-fill fields and wherein said composite form field list is produced using a mapping reference that associates one or more form fields of said selected form templates to predetermined fields of said set of pre-fill fields.

11. The computer program product of claim 10 wherein two or more of said form fields of said selected form templates are associated with one pre-fill field.

12. The computer program product of claim 7 wherein said plurality of field substitution data is limited to fillable fields of said selected form templates.

13. A propagated signal on which is carried computer-executable instructions which when executed by a computing system performs a method, the method comprising:
a) identifying dynamically one or more form fields in one or more selected form templates to produce a composite form field list;
b) generating a user-editable pre-fill dynamic form of said composite form field list, said user-editable pre-fill dynamic form including a plurality of field substitution data; and
c) generating a set of filled-in user forms wherein said field substitution data of said user-editable pre-fill dynamic form is substituted into said one or more form fields of said one or more selected form templates.

14. The propagated signal of claim 13 wherein said user-editable pre-fill dynamic form generation includes:
b1) accessing a data repository to retrieve an initial set of said field substitution data; and
b2) providing said initial set of said field substitution data for presentation in said generated user-editable pre-fill dynamic form.

15. The propagated signal of claim 14 wherein said data repository includes a first subset of field substitution data common to a set of form templates that said one or more selected form templates are selected from and includes a second subset of field substitution data variable to said set of form templates.

16. The propagated signal of claim 13 wherein said user-editable pre-fill dynamic form includes a set of pre-fill fields and wherein said composite form field list is produced using a mapping reference that associates one or more form fields of said selected form templates to predetermined fields of said set of pre-fill fields.

17. The propagated signal of claim 16 wherein two or more of said form fields of said selected form templates are associated with one pre-fill field.

18. The propagated signal of claim 13 wherein said plurality of field substitution data is limited to fillable fields of said selected form templates.

19. An apparatus comprising:
means for identifying dynamically one or more form fields in one or more selected form templates to produce a composite form field list;
means for generating a user-editable pre-fill dynamic form of said composite form field list, said user-editable pre-fill dynamic form including a plurality of field substitution data; and
means for generating a set of filled-in user forms wherein said field substitution data of said user-editable pre-fill dynamic form is substituted into said one or more form fields of said one or more selected form templates.

20. A system, comprising:
a set of form templates, each template defined using a page description language (PDL) and including one or more form fields accessible using an application programming interface (API); and
a specially-programmed computing system including resources for controlling a processor, said processor for:
receiving a user input to identify a collection of form templates, said collection selected from said set of form templates;
generating a composite field list of said form fields of said form templates of said collection using said API;
mapping said composite field list into a pre-fill field list responsive to a field map;
accessing a data repository to retrieve a plurality of substitution data for said pre-fill field list;
producing dynamically a user-editable pre-fill form having said pre-fill field list and corresponding data from said plurality of substitution data;
responding to an editing input to modify said corresponding data and produce a modified plurality of substitution data; and
generating forms from said collection of form templates using said modified plurality of substitution data and said API.

21. The system of claim 20 wherein said PDL is portable document format (PDF).

22. The system of claim 21 wherein said API includes Adobe Acrobat Software Development Kit (SDK) methods.

23. The system of claim 20 wherein said modified plurality of substitution data are stored into said data repository.
